(19) United States
(12) Patent Application Publication
(10) Pub. No.: US 2026/0147989 A1
(43) Pub. Date: May 28, 2026

(54) PROVIDING USER-GUIDED DOCUMENT STRUCTURING USING BLOCK-BASED TEMPLATES

(71) Applicant: Notion Labs, Inc., San Francisco, CA (US)

(72) Inventors: Jordan Scales, San Francisco, CA (US); Edmund Ian Kim, New York, NY (US); Connie Fan, San Francisco, CA (US)

(21) Appl. No.: 18/960,221

(22) Filed: Nov. 26, 2024

(51) Int. Cl. G06F 40/186; G06F 40/117

(52) U.S. Cl. CPC G06F 40/186; G06F 40/117

(57) ABSTRACT

The disclosed technology pertains to a block-based system for creating and organizing documents. The technology includes a method for receiving a user’s indication to create a document and providing guidance through multiple templates selected based on the user’s profile and recent activities. The system allows users to preview templates by creating temporary blocks and instantiating them into permanent blocks upon selection. The block model supports dynamic units of information that can be transformed, moved, and nested within workspaces, enabling flexible customization and organization. The system aims to simplify document creation by offering relevant templates and visualizations, enhancing user experience without extensive training.

### BACKGROUND

Traditional approaches to enhancing the usability of complex software systems have included user manuals, training programs, customizable interfaces, and user communities. User manuals and documentation, while comprehensive, are often overwhelming and underutilized. Training programs and workshops, though effective, require significant time and resources. Customizable interfaces allow experienced users to tailor their workspace but can be daunting for beginners. User communities and support forums offer peer assistance but vary in quality and require users to sift through extensive discussions. Despite these efforts, users frequently experience frustration and inefficiency due to the steep learning curve and complexity of these systems. There is a growing need for more intuitive, adaptive solutions that cater to individual user needs, streamline workflows, and reduce cognitive load.

### BRIEF DESCRIPTION OF THE DRAWINGS

Reference will now be made, by way of example, to the accompanying drawings that show example embodiments of the present application, and in which:

FIG. 1 is a block diagram of an example platform.

FIG. 2 is a block diagram of an example transformer.

FIG. 3 is a block diagram illustrating a hierarchical organization of pages in a workspace.

FIG. 4 illustrates an overview of the system to provide guidance to the user on structuring the new document.

FIG. 5 illustrates a document with multiple templates suggested to the user to structure the document.

FIG. 6A shows a preview of a “to-do list” template within the block-based system described in the application.

FIG. 6B shows the instantiation of the “to-do list” template within a document.

FIG. 7A shows a preview of a weekly plan template within the block-based system described in the application.

FIG. 7B shows the instantiation of the weekly plan template within a document.

FIG. 8A shows a preview of a journal template within the block-based system described in the application.

FIG. 8B shows the instantiation of the journal template within a document.

FIG. 9A shows a preview of a table template within the block-based system described in the application.

FIG. 9B shows the instantiation of the table template within a document.

FIG. 10 shows how the user can access additional templates that have not been explicitly suggested by the system.

FIG. 11 shows customization of the suggested templates based on user profile.

FIG. 12 is a flowchart of a method to suggest templates to enable structuring and easy discovery of a block-based system.

FIG. 13 is a block diagram that illustrates an example of a computer system 1300 in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology addresses the challenges and the daunting task of learning to use complex software by leveraging user profiles, recent activities, and artificial intelligence (AI) to provide personalized guidance and dynamic templates, thereby simplifying the user experience and enhancing productivity and satisfaction. The system provides guidance to users on structuring new documents by suggesting templates based on the user’s profile and recent activities. The user profile can include preferences, past activities, and user persona (e.g., work, personal, student). Recent activities can include interactions with recent files, calendar events, emails, and browsing history. The system suggests multiple templates that might be relevant to the user and allows the user to preview these templates by creating temporary blocks. Upon user selection, the system instantiates the chosen template as a permanent block within the document.

The technology also includes features for customizing templates based on user personas (e.g., excluding journal templates for work personas) and recent user experiences. It can use artificial intelligence to monitor user actions and provide relevant templates, such as summarizing recent activities or importing files from third-party software. The hierarchical organization of blocks within the document allows for flexible customization and efficient information management, enabling users to create well-structured and easily navigable documents.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block-based system that operates using a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block’s properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block’s parent, which can be used for permissions. Blocks can be combined with other blocks to track progress and hold all project information in one place.

A block type is what specifies how the block is rendered in a user interface (UI), and the block’s properties and content are interpreted differently depending on that type. Changing the type of a block does not change the block’s properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block’s ancestors all the way up to the root of the tree (which is the workspace). Trying to find this ancestor path by searching through all blocks’ content arrays is inefficient, especially on the client. Instead, the model uses an “upward pointer”—the parent attribute—for the permission system. The upward parent pointers and the downward content pointers mirror each other.

A block’s life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block’s properties (an empty title, and checked: ). The client builds operations to represent the creation of a new block with those attributes. New blocks are not created in isolation: blocks are also added to their parent’s content array so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model’s servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” Hypertext Transfer Protocol (HTTP) response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member’s client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the UI to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

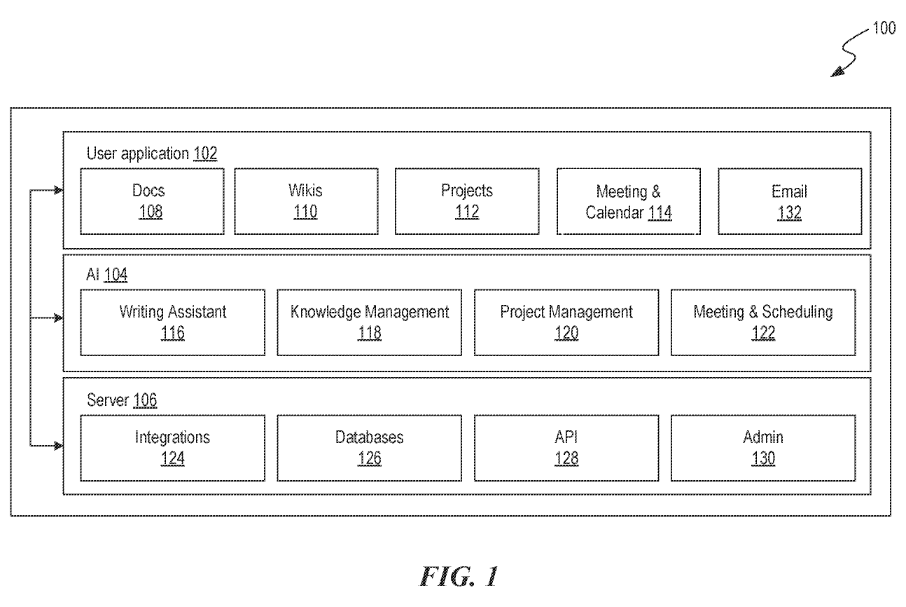

FIG. 1 is a block diagram of an example platform 100. The platform, or system, 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share with other users customized templates.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100 or an embedding of a block in the document. In another example, a wiki can link to a meeting within the calendar.

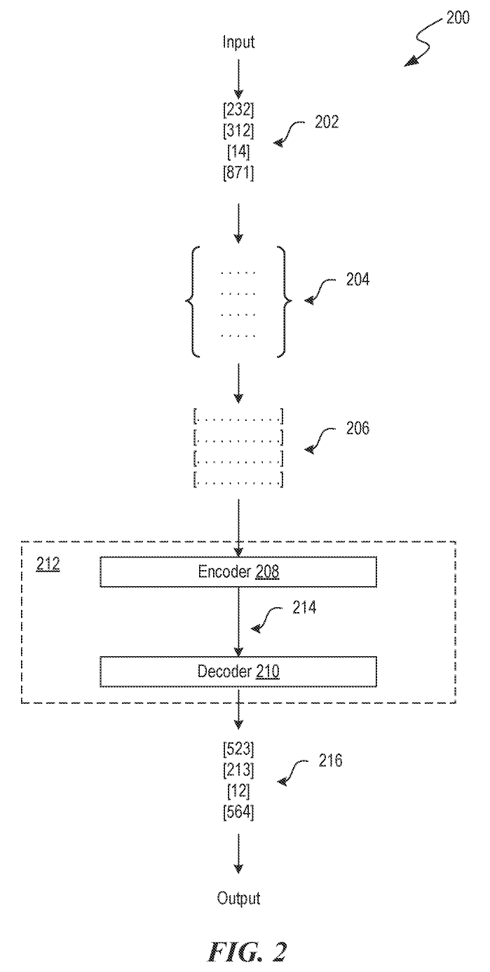

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term “DNN” can encompass any neural network having multiple layers, including convolutional neural networks (CNNs), recurrent neural networks (RNNs), multilayer perceptrons (MLPs), generative adversarial networks (GANs), variational autoencoders (VAEs), and auto-regressive models, among others.

DNNs are often used as ML-based models for modeling complex behaviors (e.g., human language, image recognition, object classification, etc.) in order to improve the accuracy of outputs (e.g., more accurate predictions) such as, for example, when compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), may represent a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performance trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger dataset and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) model are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

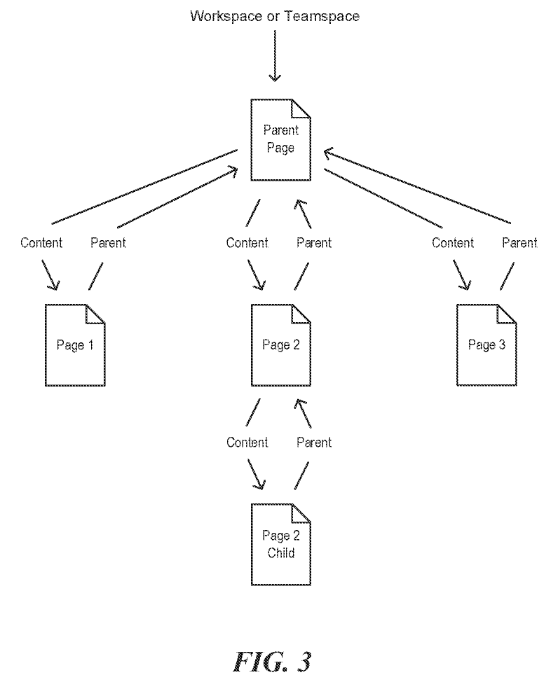

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include sub-pages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page’s access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

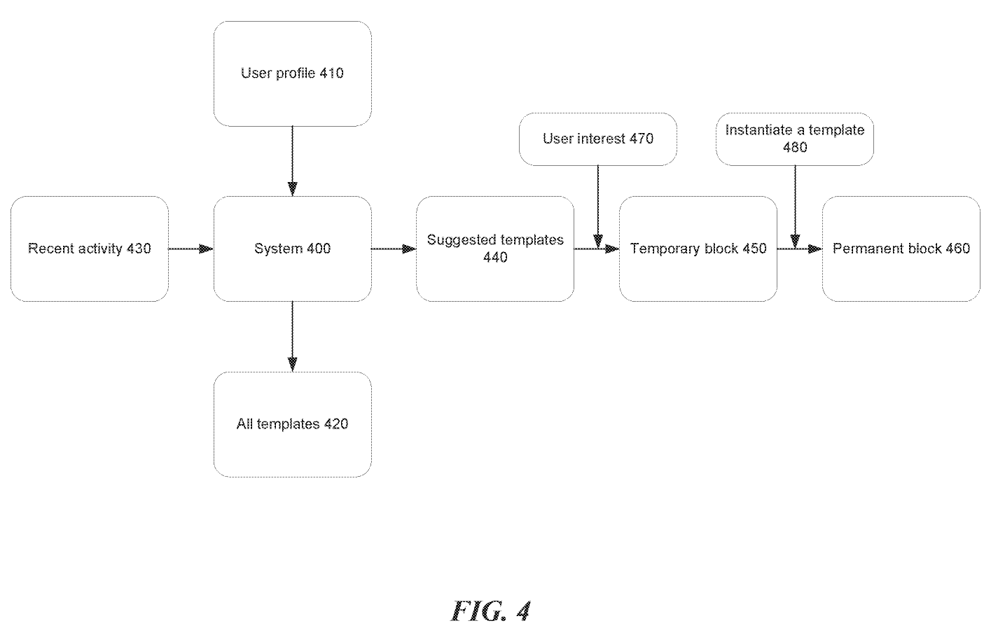

FIG. 4 illustrates an overview of the system to provide guidance to the user on structuring the new document. The system 400 can obtain information about the user such as user profile 410 and recent user activity 430. User profile 410 can include information about the user, which can include user preferences, past activities, and user persona. User persona can be work, personal, student, etc., indicating how the user is interacting with the system 400.

Recent activity 430 can include the user’s recent actions within the system, which can be used to suggest relevant templates or actions. For example, recent activity can include the recent files the user has interacted with or generated, user’s calendar, user’s emails, user’s browsing history, etc.

The system 400 can also obtain all the templates 420 available in the block-based system. Based on the user profile 410 and recent activity 430, the system 400 can suggest multiple templates 440 that might be most relevant or useful for the user, as described in this application. The system 400 can also obtain an indication of user interest 470, which can include an indicator hovering above one of the suggested multiple templates 440.

Upon obtaining the indication of user interest 470, the system 400 can create a temporary block 450 within the block-based system described in this application. The system 400 can render the temporary block 450 for previewing templates or content without making permanent changes. The system 400 can obtain an indication 480 to instantiate a template by, for example, receiving a selection of one of the templates among the multiple suggested templates 440. Upon receiving the indication 480 to instantiate a template, the system 400 can create the permanent block 460, which is stored in the block-based system described in this application.

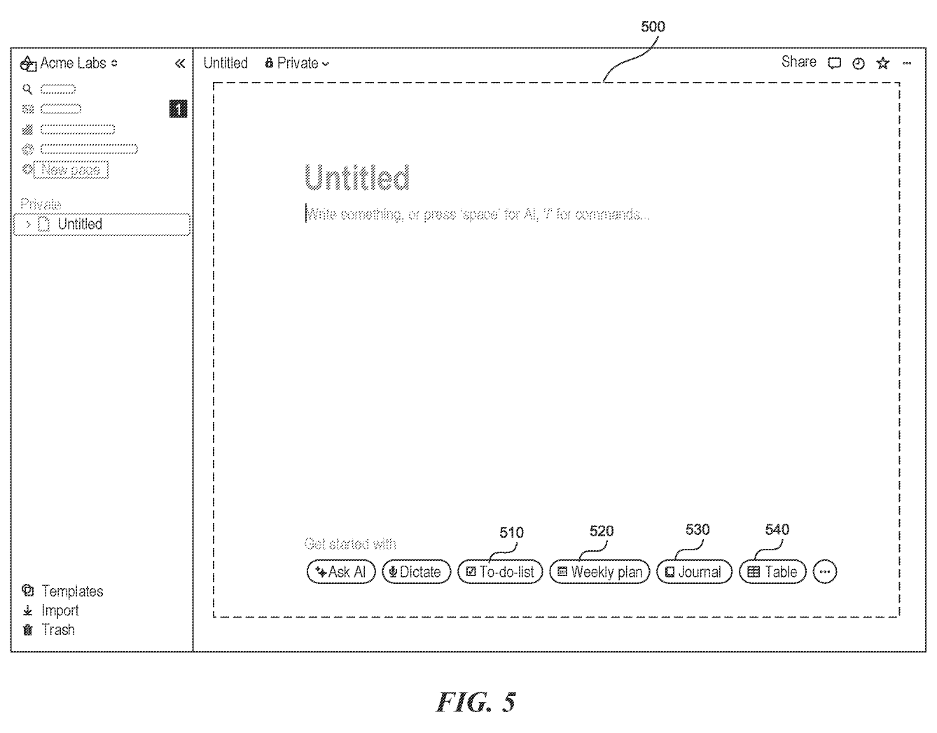

FIG. 5 illustrates a document with multiple templates suggested to the user to structure the document. Frequently, when a user is faced with an empty document 500 in a complex system, the user can feel intimidated due to the lack of knowledge of the system. The disclosed system can provide guidance to the user without requiring the user to go through lengthy training or read long documentation.

The system can present various suggested templates 510, 520, 530, 540 that can be applied to the document 500. These templates 510, 520, 530, 540 can be selected based on a profile associated with the user, which may include factors such as the user’s work or personal context, or recent actions performed by the user.

Upon receiving an indication from the user to create a document within the block-based system, the system can retrieve the user’s profile and present multiple templates 510, 520, 530, 540 configured to be applied to the document. The templates may include, but are not limited to, a to-do list 510, a weekly plan 520, a journal template 530, or a table template 540. The user can preview the templates 510, 520, 530, 540, for example, by hovering over them with a mouse to indicate interest in a particular template.

Once the user selects a template, the system creates a visualization of the selected template within the document. This visualization helps the user to structure the document effectively, leveraging the predefined blocks associated with the chosen template. The blocks within the template can include various types of content such as text, images, lists, and tables, which are dynamically organized and rendered based on the block data model described in this application.

The templates 510, 520, 530, 540 are blocks within the block-based system described in this application. The hierarchical organization of blocks within the document allows for flexible customization and organization of information, enabling users to create well-structured and easily navigable documents.

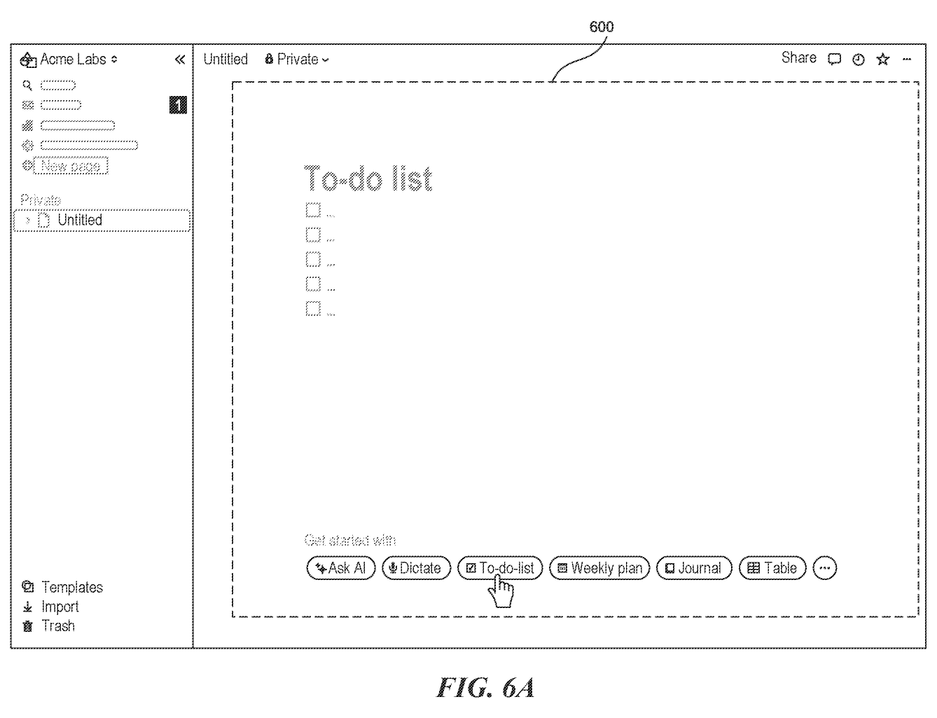

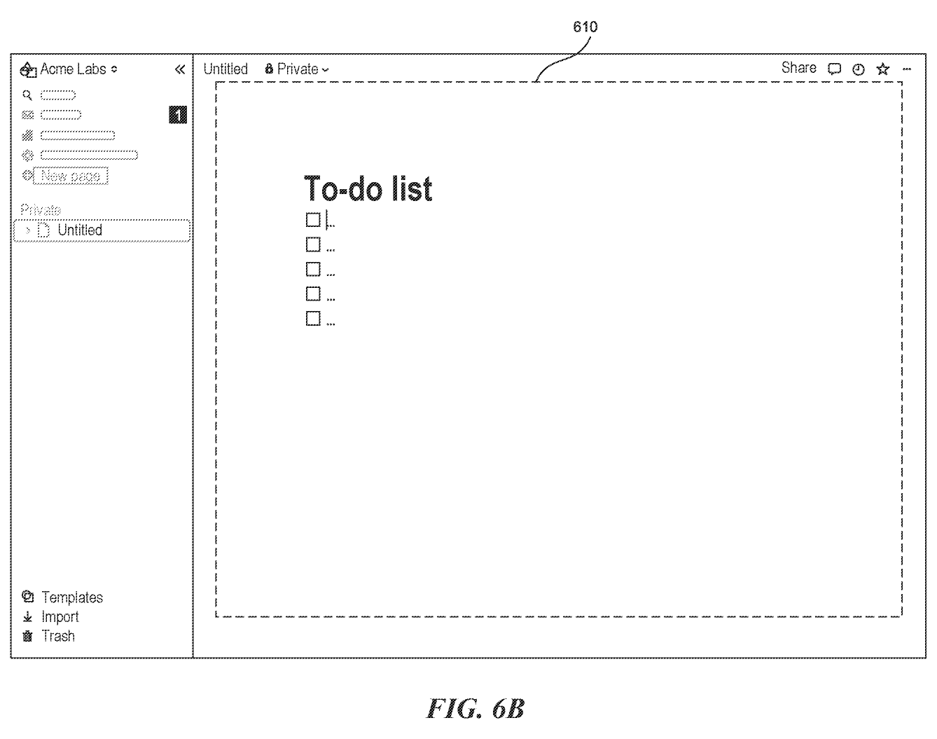

FIG. 6A shows a preview 600 of a “to-do list” template 510 within the block-based system described in the application. The preview illustrates how the to-do list will be structured and organized when instantiated. The to-do list template includes various blocks that can contain different types of content such as text, checkboxes, and other elements that are dynamically organized and rendered based on the block data model. To visualize the preview 600, the system can create the temporary block 450 in FIG. 4 without storing the temporary block in the system. The visualization of the preview 600 can indicate that the block 450 is temporary by, for example, rendering the temporary block in light gray or by making it transparent.

FIG. 6B shows the instantiation of the “to-do list” template within a document. Upon selection of the template 510 in FIG. 5 by the user, the system creates a visualization 610 of the to-do list within the document, leveraging the predefined blocks associated with the chosen template. The instantiated to-do list allows users to interact with and manage their tasks effectively, utilizing the hierarchical organization of blocks for flexible customization and organization of information. To create a visualization 610, the system can create the permanent block 460 in FIG. 4 and store the permanent block in the system. The visualization 610 can indicate that the block 460 is permanent by, for example, rendering the permanent block 460 in opaque, dark colors that are more visible than the colors of the visualization 610.

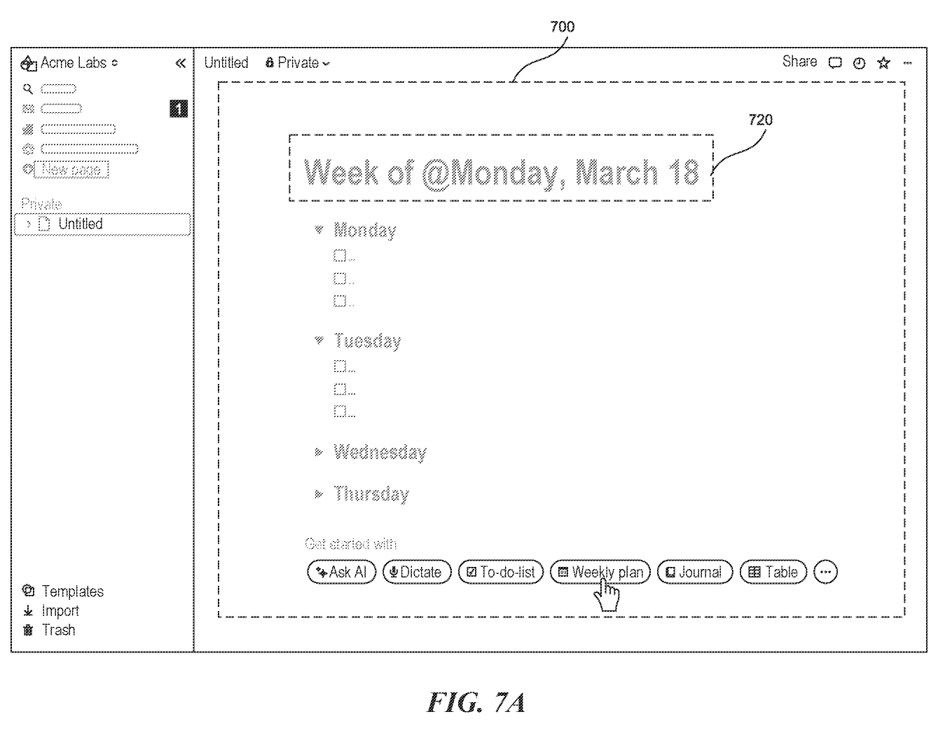

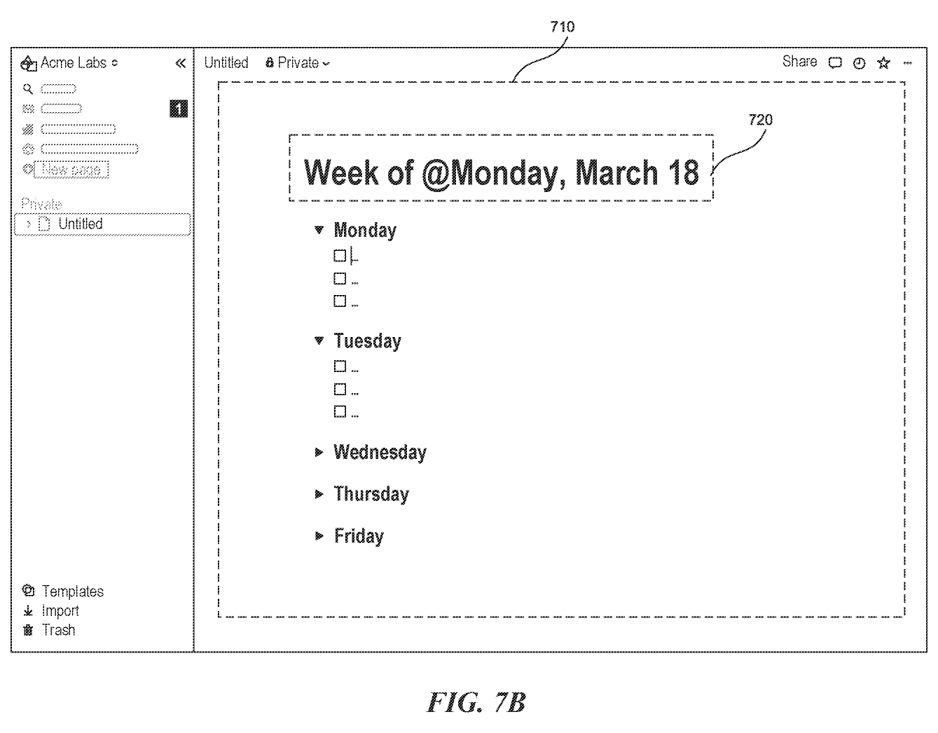

FIG. 7A shows a preview 700 of a weekly plan template 520 in FIG. 5 within the block-based system described in the application. The preview illustrates how the weekly plan will be structured and organized when instantiated. The weekly plan template includes various blocks that can contain different types of content such as text, dates, tasks, and other elements that are dynamically organized and rendered based on the block data model. To visualize the preview 700, the system can create a temporary block without storing the temporary block in the system. The visualization of the preview 700 can indicate that the block is temporary, for example, by rendering the temporary block in light gray or by making it transparent.

FIG. 7B shows the instantiation of the weekly plan template within a document. Upon selection of the template 520 in FIG. 5 by the user, the system creates a visualization 710 of the weekly plan within the document, leveraging the predefined blocks associated with the chosen template. The instantiated weekly plan allows users to interact with and manage their weekly tasks and schedules effectively, utilizing the hierarchical organization of blocks for flexible customization and organization of information. In both the visualization of preview 700 and the visualization 710, the system can generate a title 720 for the weekly plan, which can be descriptive of the template instead of leaving the title as simply “untitled.” The title 720, as shown in FIGS. 7A and 7B, can state the date, e.g., “March 18,” and indicate the time period during which the plan is applicable such as “the week of.”

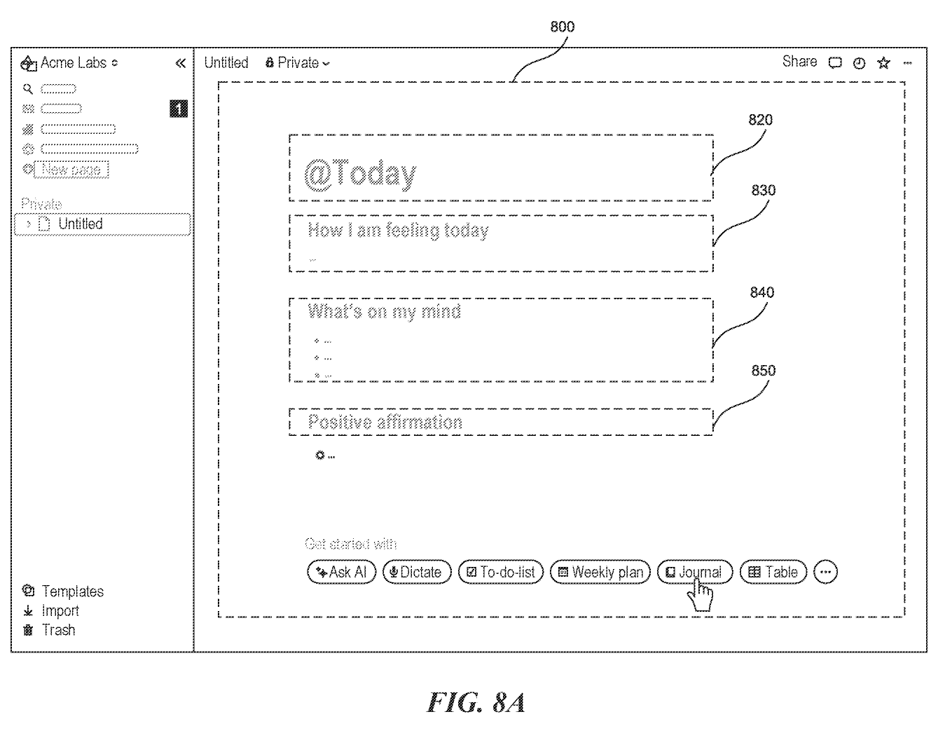

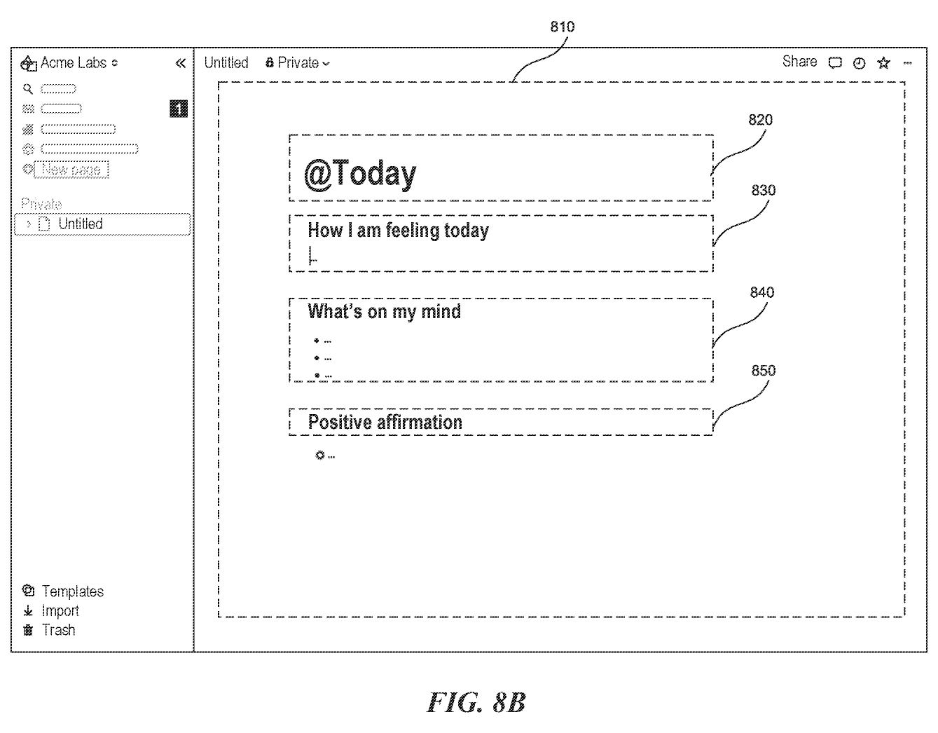

FIG. 8A shows a preview 800 of a journal template 530 in FIG. 5 within the block-based system described in the application. The preview 800 illustrates how the journal will be structured and organized when instantiated. The journal template includes various blocks that can contain different types of content such as “How I am feeling today” 830, “What’s on my mind” 840, “Positive affirmation” 850. The journal template can also include a structured list such as a bullet list, a numbered list, or checkbox list. To visualize the preview 800, the system can create a temporary block without storing the temporary block in the system. The visualization of the preview 800 can indicate that the block is temporary, for example, by rendering the temporary block in light gray or by making it transparent.

FIG. 8B shows the instantiation of the journal template 530 in FIG. 5 within a document. Upon selection of the template 530 by the user, the system creates a visualization 810 of the journal within the document, leveraging the predefined blocks associated with the chosen template. The instantiated journal allows users to interact with the predefined content by adding, deleting, and/or editing the predefined content. In both the visualization of preview 800 and the visualization 810, the system can generate a title 820 for the journal, which can be descriptive of the template, instead of leaving the title as simply “untitled.” The title, as shown in FIGS. 8A and 8B, can state the relative date (e.g., “today,” “tomorrow,” “day after tomorrow”). Once the relative date cannot be stated anymore, the system can change the date to an absolute date such as July 26, 2024. Once the content is populated, an artificial intelligence can generate an alternative title that summarizes the content of the journal.

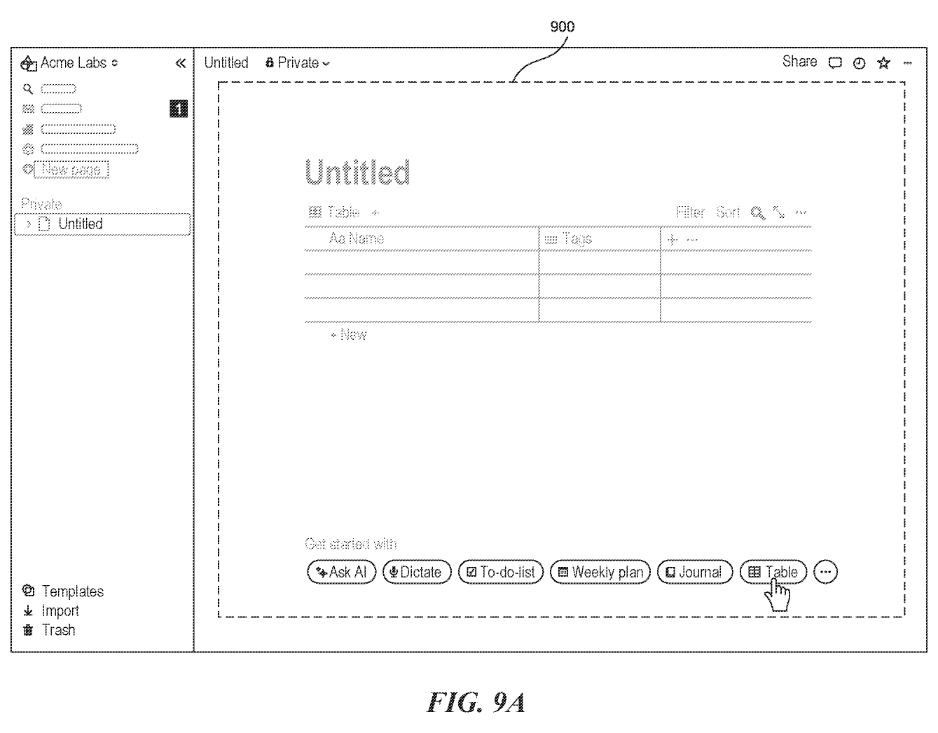

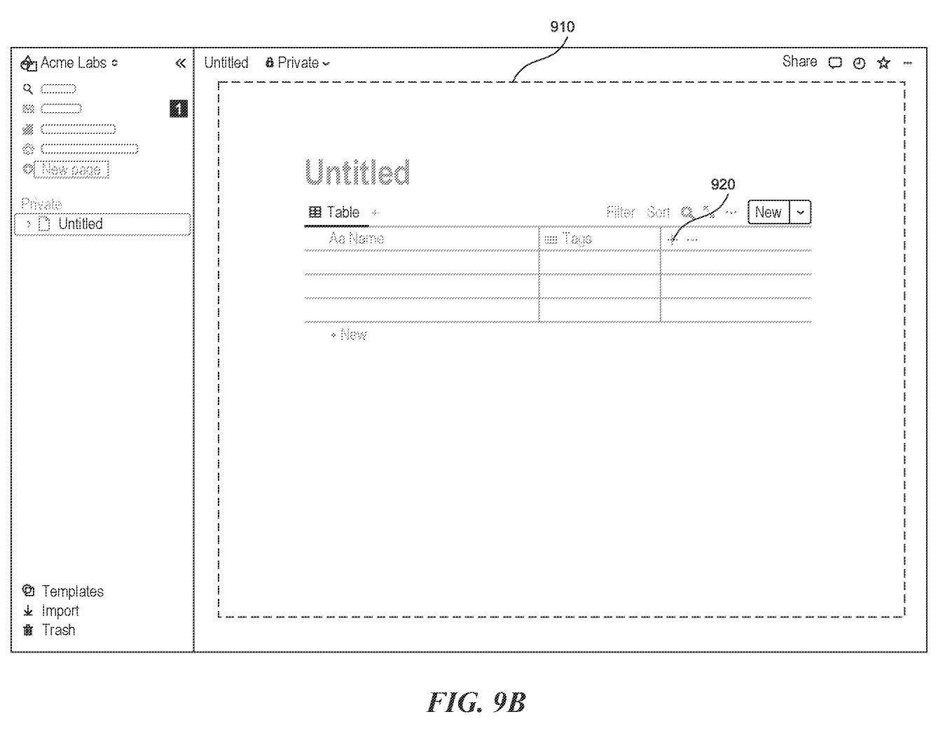

FIG. 9A shows a preview 900 of a table template 540 in FIG. 5 within the block-based system described in the application. This preview 900 demonstrates the structure and organization of the table when instantiated. The table template includes various blocks that can contain different types of content such as text, dates, tasks, and other elements, dynamically organized and rendered based on the block data model. The table template can be pre-populated with column names such as “name,” “tags.” The system can create a temporary block to visualize the preview without storing it, often rendering the preview in light gray or making the preview transparent to indicate its temporary nature.

FIG. 9B shows the instantiation of the table template 540 in FIG. 5 within a document. When a user selects the template, the system creates a visualization 910 of the table within the document, using the predefined blocks associated with the chosen template. This instantiated table allows users to interact with and manage their data effectively, utilizing the hierarchical organization of blocks for flexible customization and organization of information. The table template can include an indication 920 to create additional columns or rows.

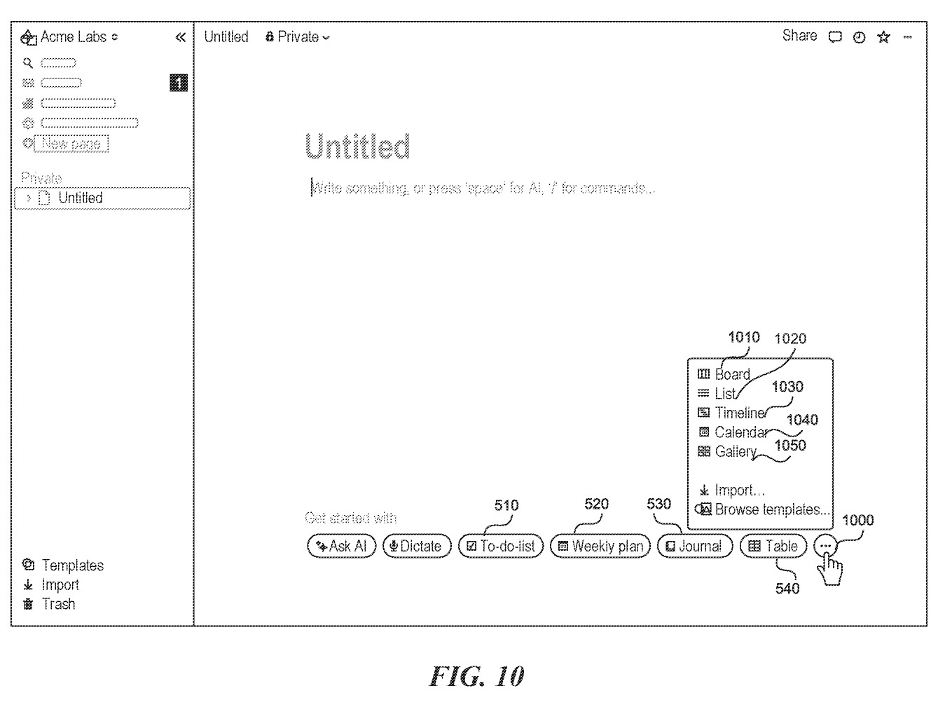

FIG. 10 shows how the user can access additional templates that have not been explicitly suggested by the system. In addition to the suggested templates 510, 520, 530, 540, the system can enable the user to discover additional templates 1010, 1020, 1030, 1040, 1050 by selecting the interface element 1000. When the user hovers over each template 1010, 1020, 1030, 1040, 1050, the system can generate a preview of the template, as described above.

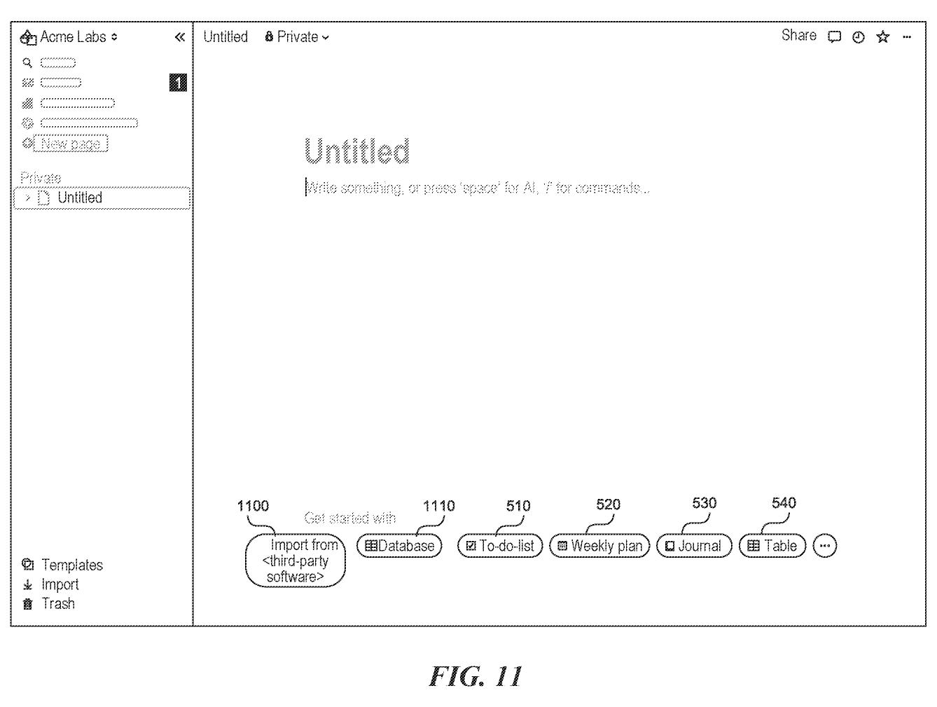

FIG. 11 shows customization of the suggested templates based on user profile. The suggested templates 510, 520, 530, 540 in FIG. 5 can be modified based on the user profile 410 in FIG. 4, as described in this application. For example, the user can indicate in the user profile 410 that the user frequently works with third-party software such as Google Docs, JIRA, or Confluence. Based on the indication, the system can provide a suggested template 1100 “import from <third-party software>,” which when selected imparts a file from third-party software into the block-based system.

Additionally, the system can determine the user experience with the block-based system, and based on the user experience, the system can suggest specific templates 1110. For example, if the user is an experienced user, the system can present a database template 1110, but if the user is a novice user, the system can hide the database template. Alternatively, if the user profile 410 indicates that the user is using the system for personal use, the system can present the journal template 530, but if the user profile 410 indicates that the user is using the system for work, the system can remove the journal template.

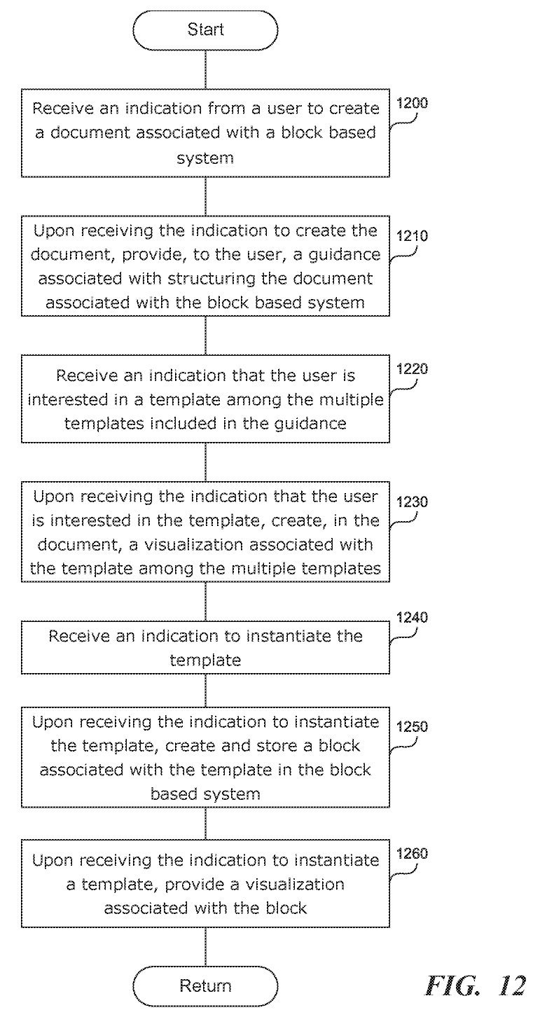

FIG. 12 is a flowchart of a method to suggest templates to enable structuring and easy discovery of a block-based system. A hardware or software processor executing instructions described in this application can in step 1200 receive an indication from a user to create a document associated with a block-based system.

In step 1210, upon receiving the indication to create the document, the processor can provide, to the user, a guidance associated with structuring the document associated with the block-based system. The guidance enables easy discovery of the block-based system without requiring the user to go through lengthy tutorials or training. The guidance can include multiple templates configured to be applied to the document, where the multiple templates can be selected based on the profile associated with the user. A template among the multiple templates includes one or more blocks associated with the block-based system. For example, the multiple templates can include a database template if the user is an experienced user, or a journal template if the user is using the system for personal use. In another example, multiple templates can include an important template if the user has files authored by third-party software such as Google Docs, JIRA, Confluence, etc. The multiple templates can include at least three of a: to-do list, a weekly plan, a journal template, or a table template.

In step 1220, the processor can receive an indication that the user is interested in a template among the multiple templates included in the guidance. The indication can include a mouse hover, a voice command expressing interest, a gesture expressing interest, etc.

In step 1230, upon receiving the indication that the user is interested in the template, the processor can create, in the document, a visualization by creating a temporary block associated with the template within the block-based system and providing the visualization associated with the temporary block, where the visualization associated with the temporary block indicates that the temporary block is not permanent. Specifically, when the user stops indicating interest, the visualization disappears from the document. To indicate the temporary nature of the visualization, the processor can represent the visualization in a color having low contrast with the background of the document, e.g., gray color if the background is white, or represent the visualization as partially transparent.

In step 1240, the processor can receive an indication to instantiate the template. In step 1250, upon receiving the indication to instantiate the template, the processor can create and store a block associated with the template in the block-based system. In step 1260, upon receiving the indication to instantiate a template, the processor can provide a visualization associated with the block, where the visualization associated with the block indicates that the visualization is permanent. For example, to indicate that the visualization is permanent, the visualization can be presented in a color that has high contrast with the color of the background in the document, e.g., black, if the background of the document is white. The visualization can also have complete or higher opacity.

The processor can use artificial intelligence to monitor an action associated with the user. The processor can provide a summary template among the multiple templates. Upon receiving a user selection of the summary template, the processor can use the artificial intelligence to provide a summary of the action to the user.

The processor can obtain recent user experience, such as files generated by the user within the last several days or a week. Based on the recent user experience, the processor can provide a second template in the multiple templates, where the second template is applicable to the recent user experience. For example, the system can determine that the user had a lot of one-on-one meetings, based on the user’s calendar. Based on the determination, the system can provide a daily summary template to the user, where the template, if selected, can provide a summary of each of the one-on-one meetings. The system can determine whether the user has meeting recordings, and if so, the system can summarize the meeting recordings to create the daily summary.

The system can obtain the user profile by obtaining an indication that the user uses a third-party software by, for example, asking the user whether the user uses Google Docs, Confluence and JIRA, etc. The system can provide a second template in the multiple templates, where the second template includes importing a file associated with the third-party software into the block-based system.

The system can obtain the user profile by obtaining a user persona including personal or work. The system can determine whether the user persona is personal or work. Upon determining that the user persona is work, the system can exclude the journal template from the multiple templates. Upon determining that the user persona is personal, the system can include the journal template and the multiple templates.

The system can enable customization of templates. The system can receive an indication of a customization to the multiple templates for a group of users, where the customization can exclude the template from the multiple templates and/or include the second template in the multiple templates. The system can determine whether the user belongs to the group of users. For example, the group of users can include users belonging to a certain department such as engineering, sales, marketing getting, facilities, etc. In another example, the group of users can belong to a particular team and/or can be defined in the block-based system. Upon determining that the user belongs to the group of users, the processor can apply the customization to the multiple templates.

The processor can obtain a profile associated with the user. The profile can include work, student, personal, recent actions, user’s calendar, emails, etc. Upon receiving the indication to create the document, the processor can provide, to the user, the guidance associated with structuring the document associated with the block-based system, where the multiple templates are selected based on the profile associated with the user. For example, if one or more meeting transcripts are associated with the user, the system can provide a template that employs artificial intelligence to summarize the meeting transcripts. The artificial intelligence can analyze the multiple transcripts to determine whether to create one or more template suggestions based on the multiple transcripts. For example, the artificial intelligence can determine whether the multiple transcripts are related, such as all of them being one-on-one meetings. If all the transcripts are one-on-one meetings, the artificial intelligence can determine that they are all related, and the system can suggest a single template to summarize all the meetings. If the transcripts are not related, such as one transcript is a one-on-one meeting and another transcript is a meeting between two or more departments to define a weekly plan, the system can suggest one template to summarize the one-on-one meeting and another template to create a weekly plan based on the meeting between two or more departments.

### Computer System

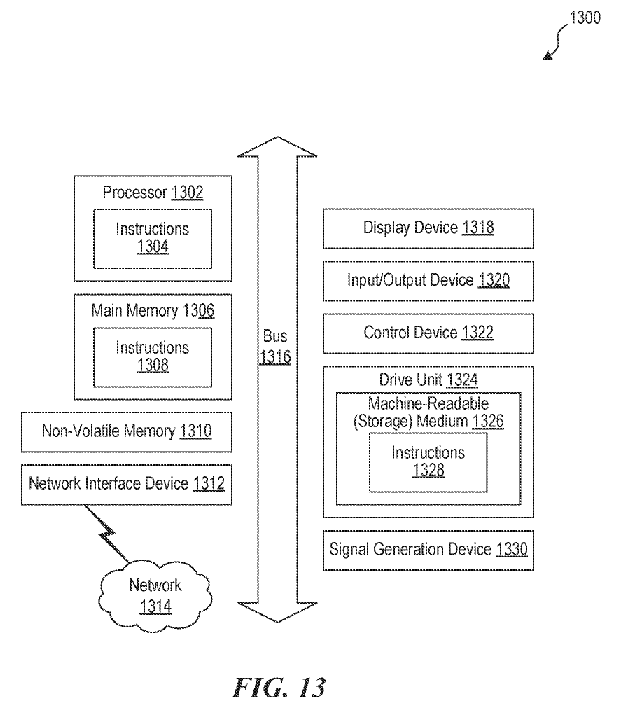

FIG. 13 is a block diagram that illustrates an example of a computer system 1300 in which at least some operations described herein can be implemented. As shown, the computer system 1300 can include: one or more processors 1302, main memory 1306, non-volatile memory 1310, a network interface device 1312, a display device 1318, an input/output device 1320, a control device 1322 (e.g., keyboard and pointing device), a drive unit 1324 that includes a machine-readable (storage) medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computer system 1300 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1300. In some implementations, the computer system 1300 can be an embedded computer system, a system-on-chip (SOC), a single-board computer (SBC) system, or a distributed system such as a mesh of computer systems or include one or more cloud components in one or more networks. Where appropriate, one or more computer systems 1300 can perform operations in real time, near real time, or in batch mode.

The network interface device 1312 enables the computer system 1300 to mediate data in a network 1314 with an entity that is external to the computer system 1300 through any communication protocol supported by the computer system 1300 and the external entity. Examples of the network interface device 1312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1306, non-volatile memory 1310, machine-readable (storage) medium 1326) can be local, remote, or distributed. Although shown as a single medium, the machine-readable (storage) medium 1326 can include multiple media (e.g., a centralized/distributed database and/or associated caches and servers) that store one or more sets of instructions 1328. The machine-readable (storage) medium 1326 can include any medium that is capable of storing, encoding, or carrying a set of instructions for execution by the computer system 1300. The machine-readable (storage) medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computer system 1300 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A non-transitory, computer-readable storage medium comprising instructions recorded thereon, wherein the instructions, when executed by at least one data processor of a system, cause the system to:
receive an indication from a user to create a document associated with a block-based system;
obtain a profile associated with the user;
upon receiving the indication to create the document, provide, to the user, a guidance associated with structuring the document associated with the block-based system,
wherein the guidance includes multiple templates configured to be applied to the document,
wherein a template among the multiple templates includes one or more blocks associated with the block-based system,
wherein the multiple templates are selected based on the profile associated with the user,
wherein the multiple templates include at least three of: a to-do list, a weekly plan, a journal template, or a table template;
receive an indication that the user is interested in the template among the multiple templates included in the guidance;
upon receiving the indication that the user is interested in the template, create, in the document, a first visualization by:
creating a temporary block associated with the template within the block-based system,
providing the first visualization associated with the temporary block,
wherein the first visualization associated with the temporary block indicates that the temporary block is not permanent;
receive an indication to instantiate the template;
upon receiving the indication to instantiate the template, create and store a block associated with the template in the block-based system; and
upon receiving the indication to instantiate the template, provide a second visualization associated with the block,
wherein the second visualization associated with the block indicates that the second visualization is permanent.

2. The non-transitory, computer-readable storage medium of claim 1, comprising instructions to:
receive an indication of a customization to the multiple templates for a group of users,
wherein the customization excludes the template from the multiple templates and/or includes a second template in the multiple templates;
determine whether the user belongs to the group of users; and
upon determining that the user belongs to the group of users, apply the customization to the multiple templates.

3. The non-transitory, computer-readable storage medium of claim 1, comprising instructions to:
use artificial intelligence to monitor an action associated with the user,
wherein the action indicates a file the user interacted with;
provide a summary template among the multiple templates; and
upon receiving a user selection of the summary template, use the artificial intelligence to provide a summary of the file to the user.

4. The non-transitory, computer-readable storage medium of claim 1, comprising instructions to:
obtain recent user experience; and
based on the recent user experience, provide a second template in the multiple templates,
wherein the second template is applicable to the recent user experience.

5. The non-transitory, computer-readable storage medium of claim 1, comprising instructions to:
obtain the profile associated with the user by obtaining an indication that the user uses a third-party software; and
provide a second template in the multiple templates,
wherein the second template includes importing a file associated with the third-party software into the block-based system.

6. The non-transitory, computer-readable storage medium of claim 1, comprising instructions to:
obtain the profile associated with the user by obtaining a user persona including personal or work;
determine whether the user persona is personal or work;
upon determining that the user persona is work, exclude the journal template from the multiple templates; and
upon determining that the user persona is personal, include the journal template and the multiple templates.

7. A system comprising:
at least one hardware processor; and
at least one non-transitory memory storing instructions, which, when executed by the at least one hardware processor, cause the system to:
receive an indication from a user to create a document associated with a block-based system;
upon receiving the indication to create the document, provide, to the user, a guidance associated with structuring the document associated with the block-based system,
wherein the guidance includes multiple templates configured to be applied to the document,
wherein a template among the multiple templates includes one or more blocks associated with the block-based system;
receive an indication that the user is interested in the template among the multiple templates included in the guidance;
upon receiving the indication that the user is interested in the template, create, in the document, a first visualization by:
creating a temporary block associated with the template within the block-based system,
providing the first visualization associated with the temporary block,
wherein the first visualization associated with the temporary block indicates that the temporary block is not permanent;
upon receiving the indication to instantiate the template, create and store a block associated with the template in the block-based system; and
upon receiving the indication to instantiate the template, provide a second visualization associated with the block,
wherein the second visualization associated with the block indicates that the second visualization is permanent.

8. The system of claim 7, comprising instructions to:
use artificial intelligence to monitor an action associated with the user;
provide a summary template among the multiple templates; and
upon receiving a user selection of the summary template, use the artificial intelligence to provide a summary of the action to the user.

9. The system of claim 7, comprising instructions to:
obtain recent user experience; and
based on the recent user experience, provide a second template in the multiple templates,
wherein the second template is applicable to the recent user experience.

10. The system of claim 7, comprising instructions to:
obtain an indication that the user uses a third-party software; and
provide a second template in the multiple templates,
wherein the second template includes importing a file associated with the third-party software into the block-based system.

11. The system of claim 7, comprising instructions to:
obtain a user persona including personal or work;
determine whether the user persona is personal or work;
upon determining that the user persona is work, exclude a journal template from the multiple templates; and
upon determining that the user persona is personal, include the journal template and the multiple templates.

12. The system of claim 7, comprising instructions to:
receive an indication of a customization to the multiple templates for a group of users,
wherein the customization excludes the template from the multiple templates and/or includes a second template in the multiple templates;
determine whether the user belongs to the group of users; and
upon determining that the user belongs to the group of users, apply the customization to the multiple templates.

13. The system of claim 7, comprising instructions to:
obtain a profile associated with the user; and
upon receiving the indication to create the document, provide, to the user, the guidance associated with structuring the document associated with the block-based system,
wherein the multiple templates are selected based on the profile associated with the user.

14. A method comprising:
receiving an indication from a user to create a document associated with a block-based system;
upon receiving the indication to create the document, providing, to the user, a guidance associated with structuring the document associated with the block-based system,
wherein the guidance includes multiple templates configured to be applied to the document,
wherein a template among the multiple templates includes one or more blocks associated with the block-based system;
receiving an indication that the user is interested in the template among the multiple templates included in the guidance;
upon receiving the indication that the user is interested in the template, creating, in the document, a first visualization by:
creating a temporary block associated with the template within the block-based system,
providing the first visualization associated with the temporary block,
wherein the first visualization associated with the temporary block indicates that the temporary block is not permanent;
receiving an indication to instantiate the template;
upon receiving the indication to instantiate the template, creating and storing a block associated with the template in the block-based system; and
upon receiving the indication to instantiate a template, providing a second visualization associated with the block,
wherein the second visualization associated with the block indicates that the second visualization is permanent.

15. The method of claim 14, comprising:
using artificial intelligence to monitor an action associated with the user;
providing a summary template among the multiple templates; and
upon receiving a user selection of the summary template, using the artificial intelligence to provide a summary of the action to the user.

16. The method of claim 14, comprising:
obtaining recent user experience; and
based on the recent user experience, providing a second template in the multiple templates,
wherein the second template is applicable to the recent user experience.

17. The method of claim 14, comprising:
obtaining an indication that the user uses a third-party software; and
providing a second template in the multiple templates,
wherein the second template includes importing a file associated with the third-party software into the block-based system.

18. The method of claim 14, comprising:
obtaining a user persona including personal or work;
determining whether the user persona is personal or work;
upon determining that the user persona is work, excluding a journal template from the multiple templates; and
upon determining that the user persona is personal, including the journal template and the multiple templates.

19. The method of claim 14, comprising:
receiving an indication of a customization to the multiple templates for a group of users,
wherein the customization excludes the template from the multiple templates and/or includes a second template in the multiple templates;
determining whether the user belongs to the group of users; and
upon determining that the user belongs to the group of users, applying the customization to the multiple templates.

20. The method of claim 14, comprising:
obtaining a profile associated with the user; and
upon receiving the indication to create the document, providing, to the user, the guidance associated with structuring the document associated with the block-based system,
wherein the multiple templates are selected based on the profile associated with the user.
